(19) United States
(12) Patent Application Publication
(10) Pub. No.: US 2006/0207930 A1
(43) Pub. Date: Sep. 21, 2006

(54) Interfacial composite structure and method of making them

(76) Inventors: Gary William Yeager, Rexford, NY (US); Sharon Oba, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/079,820

(22) Filed: Mar. 15, 2005

(51) Int. Cl. B01D 71/06

(52) U.S. Cl. 210/490; 264/41; 264/45.1; 210/500.27; 210/500.38; 210/500.37; 210/500.39; 210/504; 210/508

(57) ABSTRACT

An interfacial composite structure as well as a method of making an interfacial composite structure are disclosed. The interfacial composite structure includes a support structure; and an interfacial membrane. The interfacial membrane is formed by a first organic solution and a second organic solution. The first organic solution includes a first reactant and the second organic solution includes a second reactant. The support structure is in contact with at least one of the organic solutions and the interfacial membrane includes a crosslinked polymer formed by the first reactant and the second reactant.

### BACKGROUND OF THE INVENTION

The invention relates to interfacial composite structures. Particularly, the invention is directed to interfacial composite structures having at least one interfacial membrane formed by the interface of organic solutions.

### DESCRIPTION OF RELATED ART

It is known to produce an interfacial composite structure having an interfacial membrane formed by an aqueous solution and an organic solution. However, the aqueous solution limits a selection of monomers or polymers in the interfacial membrane to water-soluble monomers or polymers and monomers or polymers that are unreactive with water. Consequently, a need still remains for an interfacial composite structure comprising an interfacial membrane formed by two organic solutions. Also still needed are methods of making an interfacial composite structure comprising an interfacial membrane formed by two organic solutions. Also needed is an interfacial composite structure comprising an interfacial membrane formed by two organic solutions that expand the range of molecular weights and functionalities in an interfacial composite membrane beyond water-soluble monomers or polymers and monomers or polymers that are unreactive with water.

### SUMMARY

The purpose and advantages of embodiments of the invention will be set forth and apparent from the description that follows, as well as will be learned by practice of the embodiments of the invention. Additional advantages will be realized and attained by the methods and systems particularly pointed out in the written description and claims hereof, as well as from the appended drawings.

An embodiment of the invention provides an interfacial composite structure comprising a support structure and an interfacial membrane. The interfacial membrane is formed by a first organic solution and a second organic solution. The first organic solution comprises a first reactant and the second organic solution comprises a second reactant. The support structure is in contact with at least one of the organic solutions and the interfacial membrane comprises a crosslinked polymer formed by the first reactant and the second reactant.

Another embodiment provides a method of making an interfacial composite structure. The method comprises i) providing a support structure and providing a first organic solution and a second organic solution sufficiently immiscible with each other to form an interfacial membrane; wherein the support structure is in contact with at least one of the organic solutions; and wherein the first organic solution comprises a first reactant and the second organic solution comprises a second reactant; and ii) contacting the first and the second organic solutions with each other to form an interfacial membrane, wherein the interfacial membrane comprises a crosslinked polymer formed by the first reactant and the second reactant.

The accompanying figures, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a schematic representation of an interfacial composite structure in accordance with an embodiment of the invention;

FIG. 2 is another schematic representation of an interfacial composite structure in accordance with an embodiment of the invention;

FIG. 3 is a flow chart of a method of making an interfacial composite structure in accordance with an embodiment of the invention;

FIG. 4 is a scanning electronic microscopic (SEM) image of an interfacial composite structure in accordance with an embodiment of the invention; and

FIG. 5 is a another SEM image of an interfacial composite structure in accordance with an embodiment of the invention.

### DETAILED DESCRIPTION OF EXEMPLARY EMBODIMENTS

Reference will now be made in detail to exemplary embodiments of the invention, which are illustrated in the accompanying figures and examples. Referring to the drawings in general, it will be understood that the illustrations are for the purpose of describing a particular embodiment of the invention and are not intended to limit the invention thereto.

Whenever a particular embodiment of the invention is said to comprise or consist of at least one element of a group and combinations thereof, it is understood that the embodiment may comprise or consist of any of the elements of the group, either individually or in combination with any of the other elements of that group. Furthermore, when any variable occurs more than one time in any constituent or in formula, its definition on each occurrence is independent of its definition at every other occurrence. Also, combinations of substituents and/or variables are permissible only if such combinations result in stable compounds.

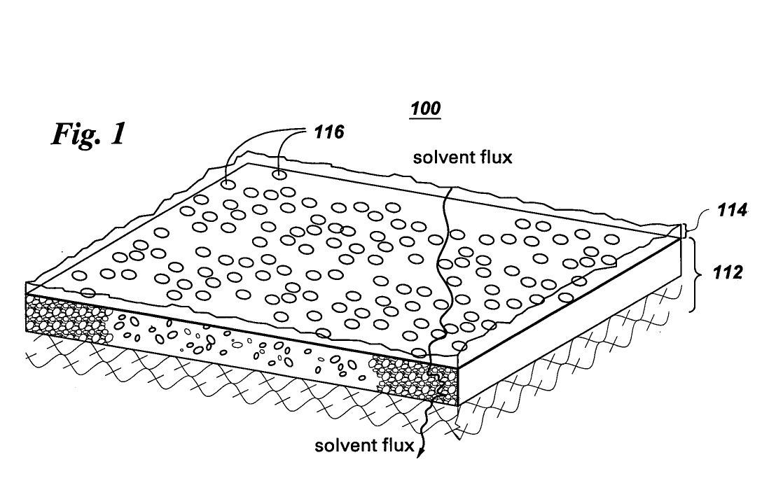

With reference to FIG. 1, an interfacial composite structure 100 is described. The interfacial composite structure 100 comprises a support structure 112; and one or more interfacial membranes 114.

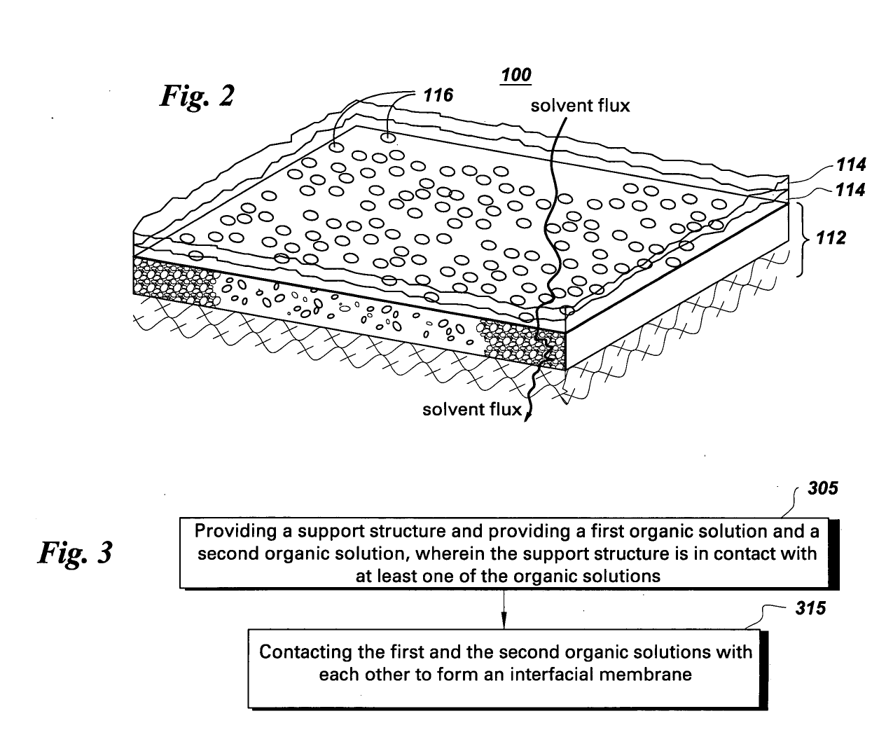

As described in FIGS. 1-2, the interfacial composite structure 100 may have one or more interfacial membranes 114 and the interfacial membrane 114 may be along different parts of the interfacial composite structure 100. FIG. 1 is a schematic representation of an interfacial composite structure 100 with one interfacial membrane 114, while FIG. 2 is another schematic representation of an interfacial composite structure 100 with a plurality of interfacial membranes 114.

The interfacial membrane 114 is formed by a first organic solution and a second organic solution sufficiently immiscible with each other to form the interfacial membrane 114. The first organic solution comprises a first reactant and the second organic solution comprises a second reactant.

The support structure 112 is in contact with at least one of the organic solutions. The support structure 112 provides mechanical stability. An example of a support structure 112 includes a glass plate. The support structure 112 may comprise various other fibrous materials such as fibrous reinforcements. Examples of fibrous reinforcements include, but are not limited to, polyester, polyphenylene sulfide, polyaramide, polytetrafluoroethylene, polypropylene, and fibrous glass. The support structure 112 may be of any shape and size, such as depth, width, length, or other dimension. In one embodiment, the support structure 112 comprises a non-woven fibrous support structure 112.

In one embodiment, the immiscibility of the two organic solutions is determined by the solubility parameter of the first and the second organic solutions. Solubility parameter is determined by the square root of the cohesive energy density. In one embodiment, the first organic solution comprises at least one solvent with Hildebrand solubility parameter approximately greater than 11 and the second organic solution comprises at least one solvent with Hildebrand solubility parameter approximately less than 7.5. Other examples of the first organic solution include, but are not limited to, dimethylforamide, dimethylacetamide, sulfolane, dimethylsulfoxide, acetonitrile, ethylene carbonate, propylene carbonate as well as other solvents with Hildebrand solubility parameter greater than 11, either individually or in any combination thereof. Other examples of the second organic solution include, but are not limited to, cyclohexane, hexane, decane, nonane, heptane, and branched isomers such as isooctane or alkene hydrocarbons such as octane as well as other solvents with Hildebrand solubility parameter approximately less than 7.5, either individually or in any combination thereof.

In another embodiment, the first and second organic solutions include such respective combinations of a first and a second organic solutions such as dimethylformamide/hexane, dimethylformamide/isopropyl ether, dimethylfor-mamide/pentane, acetonitrile/hexane, acetonitrile/pentane, acetonitrile/cyclohexane. One can also achieve a similar interfacial reaction with other immiscible organic solvent combinations and not using water.

In yet another embodiment, the first or second organic solution comprises a plurality of solvents. For example, both the first organic solution and the second organic solution may be used as binary or ternary systems by combination with other solvents, anti-solvents or additives.

The first and second reactants have chemical structures that are sufficiently different to allow the reactants to interact with each other to form a crosslinked polymer. The first and second reactants also have a respective polarity and molecular weights so as to be soluble in the respective first and second organic solutions. In addition, the first and second reactants are unreactive with the corresponding phase, in which they are dissolved.

The first reactant comprises one or more first monomers or one or more first polymers. In one embodiment, the first reactant comprises a first monomer or first polymer which has at least one functional group such as hydroxyl, amino, carboxy, aziridine, isocyanate or epoxy groups. Other examples of the first monomers and first polymers include polyethylenimines; reaction products of ethylene diamine, piperazine, methyl piperazine, dimethyl piperazine and/or homopiperazine with a poly(epihalohydrin); amine terminated polyamide oligomers; cyclohexane diamines; cyclohexane triamines; phenylene diamines; xylylene diamines; chlorophenylene diamines;benzene triamines; bis (aminobenzyl) aniline; tetra amino benzenes; tetrakis aminomethyl methane; piperazine; methyl piperazine; homopiperazine; diaminodiphenyl methanes; N,N′-diphenyl ethylene diamine; aminobenzamides; aminobenzhydrazides; bis(alkyl amino)phenylene diamines; melamine; triamino-hydroxy-pyrimidines; triamino-pyrimidines;pararosaniline; tris (aziridinyl) propionates; tetra amino biphenyls; bis (amino benzyl) anilines; mono (alkylamino) phenylene-diamines; bis (alkylamino) phenylene-diamines; aminomethylpiperidine; tetra-aminopyrimidines; N-methyl-m-phenylenediamine; and N,N′-dimethyl-m-phenylenediamine, either individually or in any combination thereof.

Other examples of the first polymers include hydroxyl, amino, aziridine, epoxy functionalized polymers such as polysiloxanes having alkyl, phenyl, fluoroalkyl or fluoroalkoxy substituents, ethylene-propylene-diene terpolymer, ethylene-propylene copolymer, urethane rubber based on polyethers or polyesters, polyethylene oxide, polypropylene oxide, block and random copolymers of polyethylene and polypropylene oxide, copolymers from propylene oxide and allyl glycidyl ether, polytetrahydrofuran, hydrogenated nitrile rubber, isobutylene-isoprene rubber (butyl rubber), polyisobutene, synthetic isoprene rubber, acrylonitrile-butadiene rubber, functionalized polybutadiene, polybutadiene-acrylonitrile rubbers, and poly(butadiene-styrene) random copolymers, either individually or in any combination thereof. p Further examples of the first polymer include polybutadiene, polyisoprene, and polybutadiene-isoprene copolymers functionalized with maleic anhydride functions, 2-hydroxyethylmaleic functions, polyfluoralkoxyphosphazene, styrene-isoprene rubber, styrene-isoprene-styrene block copolymer, polythioglycol ether, polytetrafluoroethylene, poly(vinylchloride-co-vinyl acetate-co acrylic acid), and poly(ethylene-co-vinylacetate-co-acrylic acid), either individually or in any combination thereof. Other further examples of the first polymers includethose sold under the tradename HYCAR® by B.F. Goodrich Company, including, carboxy functionalized polybutadiene rubbers such as HYCAR® 2000X162CTB (Carboxyl Equivalents=0.045; Mn=4,200; Carboxyl Equivalents per chain 1.9); HYCAR® CS 8596 (Carboxyl equivalents=0.032; Mn=6250; Carboxyl equivalents/chain=approx. 2), and carboxy terminated poly(butadiene-co-acrylonitrile) rubbers such as HYCAR®. 1300X31 CTBN (Acrylonitrile content=10%; Carboxyl Equivalents=0.050; Mn=3,800; Carboxyl equivalents/chain=1.9); HYCAR®. 1300X8 CTBN(Acrylonitrile content=18%; Carboxyl Equivalents=0.052; Mn=3,550; Carboxyl equivalents/chain=1.8) HYCAR®. 1300X13 CTBN (Acrylonitrile content=26%; Carboxyl Equivalents=0.057; Mn=3,150; Carboxyl equivalents/chain=1.8); HYCAR®.1300OX9CTBNX (Acrylonitrile content=18; Carboxyl Equivalents=0.067; Mn=3,600; Carboxyl equivalents/chain=2.4); HYCAR®. 1300X18 CTBNX (Acrylonitrile content=21.5; Carboxyl Equivalents=0.070; Mn=3,400; Carboxyl equivalents/chain=2.4), vinyl and carboxy functionalized poly(butadiene-acrylonitrile) rubbers including HYCAR®. 1300X33 VTBNX (Acrylonitrile content=18%; Carboxyl Equivalents per 100 rubber=0.009 maximum); HYCAR®. 1300X43 VTBNX (Acrylonitrile content=21.5%; Carboxyl Equivalents per 100 rubber=0.009 maximum); epoxy terminated poly(butadiene-acrylonitrile) rubber HYCAR®. 1300X40 ETBN (Carboxyl Equivalents per chain=0.027 maximum; 50% solution in styrene); amine terminated polybutadiene-acrylonitrile rubbers such as HYCAR®. 1300X21ATBN (Acrylonitrile content=10%), 1300X16ATBN (Acrylonitrile content=18%); HYCAR®. 1300X45 ATBN (Acrylonitrile content=18%); 1300X35ATBN (Acrylonitrile content=26%); and HYCAR®. 1300X42 ATBN (Acrylonitrile content=18%).

Yet even further examples of the first polymer include functionalized polybutadienes and poly(butadiene-styrene) random copolymers sold by Ricon Resins, Inc. under the trade name RICON®., RICACRYL®., and RICOBOND®. resins. These include butadienes containing both low vinyl content such as RICON®. 130, 131, 134, 142 polybutadienes containing high vinyl content such as RICON®. 150, 152, 153, 154, 156, 157, and P30D; also random copolymers of styrene and butadiene including RICON®. 100, 181, 184, and maleic anhydride grafted polybutadienes and the alcohol condensates derivatives such as RICON®. 130MA8, RICON®. MA13, RICON®. 130MA20, RICON®. 131MAS, RICON®. 131MA10, RICON®. MA17, RICON®. MA20, RICON®. 184MA6 and RICON®. 156MA17; also included are polybutadienes which may be used to improve adhesion including RICOBOND®. 1031, RICOBOND®. 1731, RICOBOND®. 2031, RICACRYL®. 3500, RICOBOND®. 1756, RICACRYL®. 3500; also are included the polybutadienes RICON®. 104 (25% polybutadiene in heptane), RICON®. 257 (35% polybutadiene in styrene), and RICON®. 257 (35% polybutadiene in styrene); also are included (meth)acrylic functionalized RICACRYL®. 3100, RICACRYL®. 3500, and RICACRYL®. 3801;also included are powder dispersions of functional polybutadiene derivatives including RICON®. 150D, 152D, 153D, 154D, P30D, RICOBOND®. 0 1731 HS, and RICOBOND®. 1756HS; also included are butadiene resins include poly(butadiene-isoprene) block and random copolymers, such as those with molecular weights from 3,000-50,000 AMU and polybutadiene homopolymers having molecular weights from 3,000-50,000 AMU, either individually or in any combination thereof. In a particular embodiment, the first reactant comprises the first polymer polysiloxane.

The second reactant comprises one or more second monomers or one or more second polymers. In one embodiment, the second reactant comprises a second monomer or second polymer which has at least one functional group such as carboxylic acids or acid chlorides, anhydride, isocyanate, chloroformate, and carbonate. Other examples of a second monomer and second polymer include, but are not limited to, acid halide-terminated polyamide oligomers; benzene dicarboxylic acid halides; benzene tricarboxylic acid halides; cyclohexane dicarboxylic acid halides; cyclohexane tricarboxylic acid halides; pyridine dicarboxylic acid halides; trimellitic anhydride acid halides; benzene tetracarboxylic acid halides; pyromellitic acid di-anhydride; pyridine tricarboxylic acid halides; sebacic acid halides; azelaic acid halides; adipic acid halides; dodecanedioic acid halides; toluene diisocyanate; methylene bis (phenyl isocyanates); naphthalene diisocyanates; bitolyl diisocyanates; hexamethylene diisocyanate; phenylene diisocyanates; haloformyloxy benzene dicarboxylic acid halides; isocyanato benzene dicarboxylic acid halides; di (halosulfonyl) benzenes; halosulfonyl benzene dicarboxylic acid halides; cyclobutane dicarboxylic acid halides; dimethyl piperazine-N,N′-diformyl halides; piperazine-N,N′-diformyl halides; xylylene glycol di-haloformates; benzene diol di-haloformates; benzene triol tri-haloformates; phosgene;diphosgene; triphosgene; N,N′-carbonyl diimidazole; isocyanuric acid-N,N′,N″-triacetyl halide; isocyanuric acid-N,N′,N″-tripropionyl halide; and cyclopentane tetracarboxylic acid halides, either individually or in any combination thereof.

In another embodiment, the first reactant comprises a plurality of monomers or polymers. Similarly, the second reactant may also comprise a plurality of monomers or polymers.

The interfacial membrane 114 comprises one or more crosslinked polymer formed by one or first reactants and one or more second reactants. Examples of crosslinked polymers include crosslinkable thermoplastics, rubbers, elastomers, and the like. Examples of crosslinkable thermoplastics include powdery engineering resins, such as polycarbonate, polyester, polyestercarbonate, polyphenylene ether, polysulfone, polyether sulfone, and polyacrylate; powdery polyolefins, such as polyethylene, polypropylene and poly-4-methyl pentene-1; fluoroplastics, such as polytetrafluoroethylene, tetrafluoroethylene-propylene copolymer; chlorinated polyethylene; ethylene vinyl acetate copolymers; polyacrlyates such as polybutyl acrylate, poly(2-hexyl acrylate); core-shell impact modifiers, such as polymethyl methacrylate-polybutylacrylate, poly(acrylonitrile-butadiene-styrene), poly(styrene-acrylonitrile) copolymers, poly(methyl methacrylate-butadiene-styrene) terpolymers; polyphenylene ether; ethylene propylene rubbers including diene modified ethylene propylene rubbers, and butadiene/styrene block copolymers. Other example of crosslinked polymers also include organic fillers such as rubbers, including acrylate-butadiene rubber, copolymers of ethyl acrylate (or other acrylates) and a small amount of a monomer that facilitates vulcanization (acrylic rubber), terpolymer from tetrafluoroethylene, trifluoronitrosomethane, and nitroso-perfluorobutyric acid (nitroso rubber), ethylacrylate-acrylonitrile copolymer (acrylate rubber), alkylene sulfide rubber, urethane rubber based on polyester, butadiene rubber (polybutadiene), bromobutyl rubber, chlorobutyl rubber, polychlorotrifluoroethylene (fluoro rubber), chloropolyethylene, epichlorohydrin homopolymer rubber (polychloromethyloxiran), chloroprene rubber (polychloroprene), chlorosulfonylpolyethylene, ethylene-ethyl acrylate copolymer (e.g., those sold by DuPont under the tradename VAMAC®.), copolymer of ethylene oxide (oxiran) and chloromethyloxiran (epichlorohydrin rubber), epoxidized natural rubber, ethylene-propylene-diene terpolymer, ethylene-propylene copolymer, urethane rubber based on polyether, epichlorohydrin-ethyleneoxide terpolymer, ethylene-vinylacetate copolymer, methyl silicone rubber with fluoro groups, rubber having fluoro or fluoroalkyl or fluoroalkoxy substituent groups on the polymer chain, copolymer from propylene oxide and allyl glycidyl ether, hydrogenated nitrile rubber, isobutylene-isoprene rubber (butyl rubber), polyisobutene, synthetic isoprene rubber, liquid silicone rubber, methyl silicone rubber, and acrylonitrile-butadiene rubber. Other examples of crosslinked polymers further include functionalized polybutadiene and polybutadiene-acrylonitrile rubbers including those sold under the tradename HYCAR®. by B.F. Goodrich Company, including, carboxy functionalized polybutadiene rubbers such as HYCAR®. 2000X162CTB (Carboxyl Equivalents=0.045; Mn=4,200; Carboxyl Equivalents per chain 1.9); HYCAR®. CS 8596 (Carboxyl equivalents=0.032; Mn=6250; Carboxyl equivalents/chain=approx. 2), and carboxy terminated poly(butadiene-co-acrylonitrile) rubbers such as HYCAR®. 1300X31 CTBN (Acrylonitrile content=10%; Carboxyl Equivalents=0.050; Mn=3,800; Carboxyl equivalents/chain=1.9); HYCAR®. 1300X8 CTBN(Acrylonitrile content=18%; Carboxyl Equivalents=0.052; Mn=3,550; Carboxyl equivalents/chain=1.8) HYCAR®. 1300X13 CTBN (Acrylonitrile content=26%; Carboxyl Equivalents=0.057; Mn=3,150; Carboxyl equivalents/chain=1.8); HYCAR®.1300OX9CTBNX (Acrylonitrile content=18; Carboxyl Equivalents=0.067; Mn=3,600; Carboxyl equivalents/chain=2.4); HYCAR®. 1300X18 CTBNX (Acrylonitrile content=21.5; Carboxyl Equivalents=0.070; Mn=3,400; Carboxyl equivalents/chain=2.4), vinyl and carboxy functionalized poly(butadiene-acrylonitrile) rubbers including HYCAR®. 1300X33 VTBNX (Acrylonitrile content=18%; Carboxyl Equivalents per 100 rubber=0.009 maximum); HYCAR®. 1300X43 VTBNX (Acrylonitrile content=21.5%; Carboxyl Equivalents per 100 rubber=0.009 maximum); epoxy terminated poly(butadiene-acrylonitrile) rubber HYCAR®. 1300X40 ETBN (Carboxyl Equivalents per chain=0.027 maximum; 50% solution in styrene); amine terminated polybutadiene-acrylonitrile rubbers such as HYCAR®. 1300X21ATBN (Acrylonitrile content=10%), 1300X16ATBN (Acrylonitrile content=18%); HYCAR®. 1300X45 ATBN (Acrylonitrile content=18%); 1300X35ATBN (Acrylonitrile content=26%); HYCAR®. 1300X42 ATBN (Acrylonitrile content=18%); also included are the functionalized polybutadienes and poly(butadiene-styrene) random copolymers sold by Ricon Resins, Inc. under the trade name RICON®., RICACRYL®., and RICOBOND®. resins these include butadienes containing both low vinyl content such as RICON®. 130, 131, 134, 142 polybutadienes containing high vinyl content such as RICON®. 150, 152, 153, 154, 156, 157, and P30D; also random copolymers of styrene and butadiene including RICON®. 100, 181, 184, and maleic anhydride grafted polybutadienes and the alcohol condensates derived therefrom such as RICON®. 130MA8, RICON®. MA13, RICON®. 130MA20, RICON®. 131MAS, RICON®. 131MA10, RICON®. MA17, RICON®. MA20, RICON®. 184MA6 and RICON®. 156MA17; also include are polybutadienes which may be used to improve adhesion including RICOBOND®. 1031, RICOBOND®. 1731, RICOBOND®. 2031, RICACRYL®. 3500, RICOBOND®. 1756, RICACRYL®. 3500; also are included the polybutadienes RICON®. 104 (25% polybutadiene in heptane), RICON®. 257 (35% polybutadiene in styrene), and RICON®. 257 (35% polybutadiene in styrene); also are included (meth)acrylic functionalized RICACRYL®. 3100, RICACRYL®. 3500, and RICACRYL®. 3801; also are included are powder dispersions of functional polybutadiene derivatives including, for example, RICON®. 150D, 152D, 153D, 154D, P30D, RICOBOND®. 0 1731 HS, and RICOBOND®. 1756HS. Further butadiene resins include poly(butadiene-isoprene) block and random copolymers, such as those with molecular weights from 3,000-50,000 AMU and polybutadiene homopolymers having molecular weights from 3,000-50,000 AMU. Also included are polybutadiene, polyisoprene, and polybutadiene-isoprene copolymers functionalized with maleic anhydride functions, 2-hydroxyethylmaleic functions, or hydroxylated functionality. Example of crosslinked polymers further include crosslinkable polyacrylonitrile-chloroprene, polyacrylonitrile-isoprene, polyisoprene, polyglycol ethers, such as polypropylene glycol, polyethylene glycol, polyethylene glycol-polypropylene glycol block and random copolymers, polytetrahydrofuran, polypropylene oxide-allylglycidyl ether copolymers, polyvinylpyridine-butadiene, polyethylene, and methyl silicone rubbers and fluids with vinyl or phenyl groups. Example of crosslinked polymers may also include crosslinkable polyfluoralkoxyphosphazene, polynorbornene, polypropylene, vinylpyridine-styrene-butadiene rubber, polyurethanes, methyl silicones with phenyl and vinyl groups, polystyrene-butadiene, styrene-butadiene-styrene block copolymer, styrene-chloroprene rubber, polysiloxane treated EPDM, styrene-isoprene rubber, styrene-isoprene-styrene block copolymer, polythioglycol ether, polytetrafluoroethylene, polysulfide rubbers, trans-polyoctenamer, trans-polypentenamer, polyurethanes, polyethylene, poly(vinylchloride-co-vinyl acetate-co acrylic acid), and poly(ethylene-co-vinylacetate-co-acrylic acid).

In one embodiment, the interfacial composite structure 100 comprises pores 116 with an average size in the range from about 1 nm to about 10,000 nm. The interfacial composite structure 100 may be symmetric, where the sizes of the pores 116 are similar across a gradient, or asymmetric, where the sizes of the pores 116 vary across a gradient. In one embodiment, the support structure 112 comprises a fibrous support structure.

In a particular embodiment, the crosslinked interfacial composite structure 100 is crosslinked by an oxygenated hydrocarbon. The crosslink density changes with the relative proportions of the first and second reactants and may vary widely. Generally the crosslinking is performed such that the molecular weight between crosslink sites in the crosslinked polymer is from 200 to 50,000 g/mol, particularly from between 400 and 20,000 g/mol and most particularly from between 400 and 3,000 g/mol.

The interfacial composite structure 100 can be used in various applications such as, nanofiltration, reverse osmosis, piezodialysis, gas separations, pervaporation, and membrane distillation. The details of these processes, such as temperatures and pressures, as known in the art. The traditional interfacial membrane process in which an interfacial membrane is formed between an aqueous phase and an organic phase is limited to monomers or polymer reactants that are soluble in water. In contrast, the interfacial composite structure 100 of the present invention allows monomers and polymers that are not miscible in water to be formed at the interfacial membrane of two immiscible organic solvents. An advantage of the interfacial composite structure 100 allows reaction between oligomers and crosslinkers in which one can also control the crosslink density by changing the molecular weight of the oligomer or the amount or type of crosslinker. Another advantage of the interfacial composite structure 100 includes its adaptability to the currently available manufacturing processes for reverse osmosis membranes.

With reference to FIG. 3, next will be described a method of making an interfacial composite structure 100. FIG. 3 is a flow chart of a method of making an interfacial composite structure 100.

As described in FIG. 3, the method comprises, at Step 305, providing a support structure 112 and providing a first organic solution and a second organic solution sufficiently immiscible with each other to form an interfacial membrane 114. The support structure 112 is in contact with at least one of the organic solutions. The first organic solution comprises a first reactant and the second organic solution comprises a second reactant as previously described hereinabove. Step 315 comprises contacting the two organic solutions with each other to form an interfacial membrane 114, wherein the interfacial membrane 114 comprises a polymer formed by the first reactant and the second reactant.

The method is not limited by when the first and second organic solutions are provided. Not being limited by when the first and second organic solutions are provided also means that the method is not limited by when the first and second organic solutions are in contact with each other. Consequently, since the interfacial membrane 114 is formed by the contact of the first and second organic solution with each other, not being limited by when the first and second organic solutions are in contact with each other also means that the method is not limited by the location of the interfacial membrane 114. In one embodiment, the first and second organic solutions are simultaneously provided, such as simultaneously disposed on the support structure 112. In another embodiment, the first and second organic solutions are provided sequentially. In particular embodiment, the method comprises providing the first organic solution before providing the second solution.

The process of providing a first and second organic solution to form an interfacial membrane 114 may be repeated with a plurality of first and second organic solutions to form multiple interfacial membranes 114.

The temperature of the solutions when contacting the first and second organic solutions with each other may be varied depending upon the desired properties of the interfacial composite structure 100, such as resistance to a liquid. In one example, the temperature may be kept in a range from about 0° C. to about 60° C. and particularly from about 25° C. to about 30° C. The interfacial composite structure 100 may be washed free from any strongly acidic solution with a non-acidic solution such as deionized water.

The crosslinked polymer may further include additives and adjunct materials so long as they do not inhibit the first and second reactant. Examples of additives and adjunct materials include plasticizers, ionicity enhancers, wetting agents such as surfactants, desorption agents, surface modifiers, smoothing agents, acid acceptors, flux enhancing agents, drying agents, antifoaming agents, thickeners and defoaming agents. Other example of additives and materials are described in U.S. Patent No. in U.S. Pat. Nos. 4,948,507; 4,983,291; and 5,658,460.

Examples of other additives and adjunct materials include ammonium salts of acids, primary, secondary, and tertiary ammonium salts of acids, quaternary ammonium salts of acids, glycols, organic acids, saccharides, and the like. Examples include glycerin, citric acid, glycols, glucose, sucrose, triethylammonium camphorsulfonate, triethylammonium benzenesulfonate, triethylammonium toluenesulfonate, triethylammonium methane sulfonate, ammonium camphor sulfonate, and ammonium benzene sulfonate. The method is not limited by when the additives and adjunct materials are provided. The additives and adjunct materials may be provided to the crosslinked polymers by adding the additives and adjunct materials to one of the organic solvent phases before the interfacial membrane 114 is formed or by providing the additives and adjunct materials directly to the interfacial membrane 114 before or after the crosslinked polymer is formed.

Furthermore, catalysts may also be used to aid in the formation of the interfacial membrane 114 by accelerating the reaction between the first and second reactant. Examples of catalysts include, but are not limited to, diethylamine, ethylene diamine, triethanolamine, diethanolamine, ethanolamine, dimethylaminopyridine.

The interfacial membrane 114 may be further processed to remove residual chemicals, adjust performance, and/or to apply a protective coating. For example, post formation treatment with chlorinating agents, amine alkylating agents, oxidizing agents and the like may provide performance improvements. After such optional treatment, the interfacial membrane 114 is ready for use. The interfacial membrane 114 may also be stored for later use.

It should be appreciated that the method of forming membranes include other methods known to the art, such as film stretching, template leaching, nucleation track etching, sintering, solution casting or extrusion.

### EXAMPLE 1 Synthesis of Bis(aminopropyl) poly(trifluoropropylmethylsiloxane) (PTFPMS) Reactant One

PTFPMS was prepared by polymerization of trifluoropropylcyclo-siloxane and bis(3-aminopropyl)- 1,1,3,3-tetramethyldisiloxane chainstopper. TMAH/5H2O was used as a catalyst and the mixture was stirred at room temperature for 12 hours while the flask was evacuated to 50 mtorr to remove crystal water brought along with the catalyst. The flask was placed into an isothermal bath at 70° C. The molecular weight was monitored using GPC since the reaction needs to be stopped at target molecular weight because equilibrium polymerization will result in very low molecular weight. After the reaction, the mixture was heated to 150° C to decompose TMAH. The maximum molecular weight achieved using this procedure was approximately 8500 g/mol.

### EXAMPLE 2 Synthesis of the Bis(aminopropyl) poly(cyanopropylmethylsiloxane) (PCPMS) Reactant One

A one-neck flask with a magnetic stir bar was charged with 10.8 g DxCN (x=3-5), 1.2g of 1,3-bis(3-aminopropyl)-1,1,3,3-tetramethyldisiloxane chainstopper and 4.3 mg (0.024mmol) TMAH/5H2O. The mixture was stirred at room temperature for 2 hours and the flask was evacuated to 50 mtorr to remove crystal water brought in along with the catalyst. The water is an inhibitor of the reaction. The flask was placed in an isothermal oil bath at 70° C. After 48 hours, the equilibrate was heated to 150° C. and purged with dry nitrogen to decompose the catalyst and removed the resultant trimethylamine. The maximum molecular weight achieved was 3500 g/mol.

### EXAMPLE 3 Preparation of Interfacial Composite Structure (100)

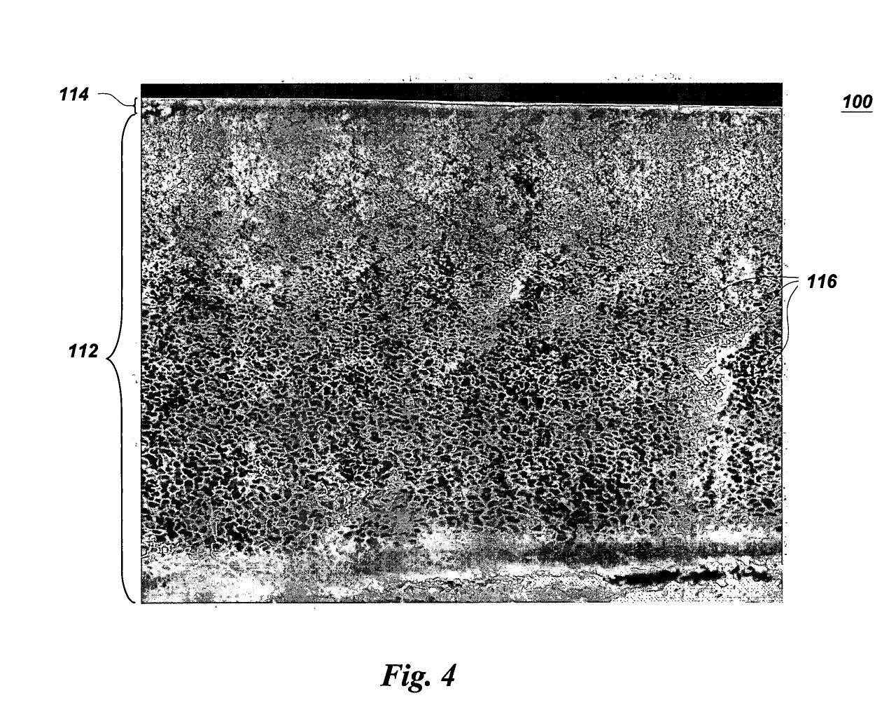

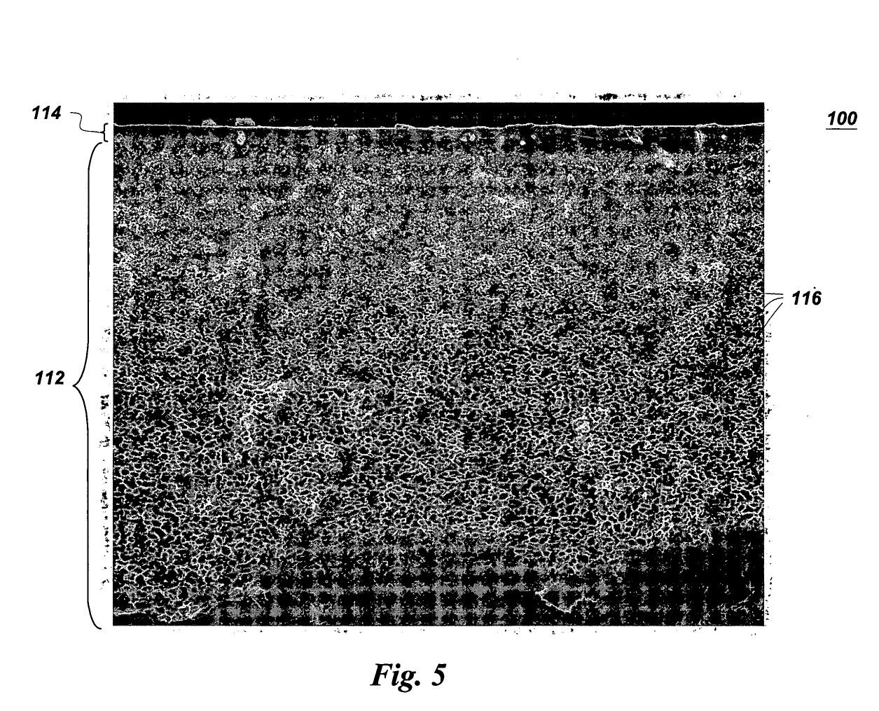

GE Osmonics supplied a crosslinked polysulfone support 112. An organic immiscible dimethylforamide solution 1 containing 25 wt % polysiloxane (reactant 1) was cast onto the crosslinked polysulfone support 112 and any excess solution was removed. The crosslinked polysulfone 112 was placed in a 110° C. for 10 minutes. Solution 1 was cast onto the crosslinked polysulfone support 112 for the second time. Any excess solution was removed and the crosslinked polysulfone 112 was placed in a 110° C. for 10 minutes. An organic immiscible hexane solution 2 containing 2 wt % trimesoyl chloride (reactant 2) was poured on the crosslinked polysulfone 112 and was allowed to sit on top for 2-3 minutes. The excess hexane was poured off and the interfacial composite structure 100 was placed in the oven at 110° C. for 20-30 minutes to cure. An interfacial composite structure 100 described in Table 1 as 3-a was prepared by using reactant 1 synthesized in Example 1 and interfacial composite structure 3-b was prepared by using reactant 1 synthesized by Example 2. Both interfacial composite structures 3-a and 3-b described in Table 1 were made by using trimesoyl chloride as reactant 2. FIG. 4 and 5 shows SEM images of interfacial composite structures 3-a and 3-b, respectively

### EXAMPLE 4 Interfacial Composite Structure 100 Performance

The A-value is a flux normalized by the pressure, a unit defined by the permeate flux divided by pressure. The interfacial composite structures 3-a and 3-b described in Table 1 were evaluated by their ability to separate 300 ppm of Sudan IV in acetone. Sudan IV was chosen due to its similar molecular weight to molecules separated in pharmaceutical industry and also due to its ease of characterization. Since Sudan IV is a red dye, UV/V spectrometer was used to determine the change in concentration of the permeate compared to the feed. The results summarized in Table 1 shows that interfacial composite structure 3-b demonstrated better performance in rejecting Sudan IV in acetone compared to interfacial composite structure 3-a.

TABLE 1
Results of separation of Sudan IV in Acetone

| | Reactant 1/ | Reactant 2/ | Rejection | A-value Flux |
|---|---|---|---|---|
| Example | Solution 1 | Solution 2 | (%) | (ml/m²/s/psi) |
| 3-a | PTFPMS/DMF | Trimesoyl | 59 | negligible |
| | | chloride/Hexane | | |
| 3-b | PCPMS/DMF | Trimesoyl | 82 | 0.47 |
| | | chloride/Hexane | | |

While the invention has been described in detail in connection with only a limited number of aspects, it should be readily understood that the invention is not limited to such disclosed aspects. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An interfacial composite structure comprising:
a) a support structure; and
b) an interfacial membrane formed by a first organic solution and a second organic solution, wherein the first organic solution comprises a first reactant and the second organic solution comprises a second reactant;
wherein the support structure is in contact with at least one of the organic solutions; and
wherein the interfacial membrane comprises a crosslinked polymer formed by the first reactantand the second reactant.

2. The interfacial composite structure of claim 2, wherein the crosslinked interfacial composite structure is crosslinked by an oxygenated hydrocarbon.

3. The interfacial composite structure of claim 1, wherein the first organic solution comprises a solvent with a Hildebrand solubility parameter approximately greater than 11.

4. The interfacial composite structure of claim 1, wherein the first organic solution comprises at least one member selected from a group consisting of dimethylforamide, dimethylacetamide, sulfolane, dimethylsulfoxide, acetonitrile, ethylene carbonate, and propylene carbonate.

5. The interfacial composite structure of claim 1, wherein the first organic solution comprises a plurality of solvents.

6. The interfacial composite structure of claim 1, wherein the second organic solution comprises a solvent with a Hildebrand solubility parameter approximately less than 7.5.

7. The interfacial composite structure of claim 1, wherein the second organic solution comprises at least one member selected from a group consisting of cyclohexane, hexane, decane, nonane, heptane, and branched isomers.

8. The interfacial composite structure of claim 1, wherein the second organic solution comprises a plurality of solvents.

9. The interfacial composite structure of claim 1, wherein the support structure comprises a fibrous support structure.

10. The interfacial composite structure of claim 1, wherein the interfacial composite structure comprises pores with an average size in a range from about 1 nm to 10,000 nm.

11. The interfacial composite structure of claim 1, wherein the interfacial composite structure comprises a plurality of interfacial membranes.

12. The interfacial composite structure of claim 1, wherein the first reactant comprises a first monomer or first polymer which has at least one functional group selected from a group consisting of hydroxyl, amino, carboxy, aziridine, isocyanate, and epoxy.

13. The interfacial composite structure of claim 1, wherein the first reactant comprises a first monomer or first polymer selected from a group consisting of polyethylenimines; a reaction product between a poly(epihalohydrin ) and a member selected from a group consisting of ethylene diamine, piperazine, methyl piperazine, dimethyl piperazine, and homopiperazine; amine terminated polyamide oligomers; cyclohexane diamines; cyclohexane triamines; phenylene diamines; xylylene diamines; chlorophenylene diamines;benzene triamines; bis (aminobenzyl) aniline; tetra amino benzenes; tetrakis aminomethyl methane; piperazine; methyl piperazine; homopiperazine; diaminodiphenyl methanes; N,N′-diphenyl ethylene diamine; aminobenzamides; aminobenzhydrazides; bis(alkyl amino)phenylene diamines; melamine; triamino-hydroxy-pyrimidines; triamino-pyrimidines;pararosaniline; tris (aziridinyl) propionates; tetra amino biphenyls; bis (amino benzyl) anilines; mono (alkylamino) phenylene-diamines; bis (alkylamino) phenylene-diamines; aminomethylpiperidine; tetra-aminopyrimidines; N-methyl-m-phenylenediamine; N,N′-dimethyl-m-phenylenediamine, and combinations thereof.

14. The interfacial composite structure of claim 1, wherein the first reactant comprises a first polymer polysiloxane.

15. The interfacial composite structure of claim 1, wherein the second reactant comprises a second monomer or second polymer which has at least one functional group selected from a group consisting of carboxylic acids or acid chlorides, anhydride, isocyanate, chloroformate, and carbonate.

16. The interfacial composite structure of claim 1, wherein the second reactant comprises a second monomer or second polymer selected from a group consisting of acid halide-terminated polyamide oligomers; benzene dicarboxylic acid halides; benzene tricarboxylic acid halides; cyclohexane dicarboxylic acid halides; cyclohexane tricarboxylic acid halides; pyridine dicarboxylic acid halides; trimellitic anhydride acid halides; benzene tetracarboxylic acid halides; pyromellitic acid di-anhydride; pyridine tricarboxylic acid halides; sebacic acid halides; azelaic acid halides; adipic acid halides; dodecanedioic acid halides; toluene diisocyanate; methylene bis (phenyl isocyanates); naphthalene diisocyanates; bitolyl diisocyanates; hexamethylene diisocyanate; phenylene diisocyanates; haloformyloxy benzene dicarboxylic acid halides; isocyanato benzene dicarboxylic acid halides; di (halosulfonyl) benzenes; halosulfonyl benzene dicarboxylic acid halides; cyclobutane dicarboxylic acid halides; dimethyl piperazine-N,N′-diformyl halides; piperazine-N,N′-diformyl halides; xylylene glycol di-haloformates; benzene diol di-haloformates; benzene triol tri-haloformates; phosgene;diphosgene; triphosgene; N,N′-carbonyl diimidazole; isocyanuric acid-N,N′,N″-triacetyl halide; isocyanuric acid-N,N′,N″-tripropionyl halide; cyclopentane tetracarboxylic acid halides and combinations thereof.

17. The interfacial composite structure of claim 1, wherein the first reactant comprises a plurality of reactants.

18. The interfacial composite structure of claim 1, wherein the second reactant comprises a plurality of reactants.

19. A method of making an interfacial composite structure comprising:
i) providing a support structure and providing a first organic solution and a second organic solution sufficiently immiscible with each other to form an interfacial membrane;
wherein the support structure is in contact with at least one of the organic solutions; and wherein the first organic solution comprises a first reactant and the second organic solution comprises a second reactant; and
ii) contacting the first and the second organic solutions with each other to form an interfacial membrane, and
wherein the interfacial membrane comprises a crosslinked polymer formed by the first reactantand the second reactant.

20. The method of claim 19, wherein providing the first and the second organic solution comprises sequentially providing the first and second organic solution.

21. The method of claim 20, wherein providing the first and the second organic solution comprises providing the first solution before the second organic solution.

22. The method of claim 19, wherein providing the first and the second organic solution comprises simultaneously providing the first and second organic solution.

23. The method of claim 19, wherein contacting the first and the second organic solution comprises heating the first solution and the second organic solution.

24. The method of claim 19, wherein the interfacial composite structure is crosslinked.

25. The method of claim 19, wherein the first organic solution comprises at least one member selected from a group consisting of dimethylforamide, dimethylacetamide, sulfolane, dimethylsulfoxide, acetonitrile, ethylene carbonate, and propylene carbonate.

26. The method of claim 19, wherein the first organic solution comprises a plurality of solvents.

27. The method of claim 19, wherein the second organic solution comprises a solvent with a Hildebrand solubility parameter approximately less than 7.5.

28. The method of claim 19, wherein the second organic solution comprises at least one member selected from a group consisting of cyclohexane, hexane, decane, nonane, heptane, and branched isomers.

29. The method of claim 19, wherein the second organic solution comprises a plurality of solvents.

30. The method of claim 19, wherein the support structure comprises a fibrous support structure.

31. The method of claim 19, wherein the interfacial composite structure comprises pores with an average size in a range from about 1 nm to 10,000 nm.

32. The method of claim 19, wherein the interfacial composite structure comprises a plurality of interfacial membranes.

33. The method of claim 19, wherein the first reactant comprises a first monomer or first polymer which has at least one functional group selected from a group consisting of hydroxyl, amino, carboxy, aziridine, isocyanate, and epoxy groups.

34. The method of claim 19, wherein the first reactant comprises a first monomer or first polymer selected from a group consisting of polyethylenimines; a reaction product between a poly(epihalohydrin ) and a member selected from a group consisting of ethylene diamine, piperazine, methyl piperazine, dimethyl piperazine, and homopiperazine; amine terminated polyamide oligomers; cyclohexane diamines; cyclohexane triamines; phenylene diamines; xylylene diamines; chlorophenylene diamines;benzene triamines; bis (aminobenzyl) aniline; tetra amino benzenes; tetrakis aminomethyl methane; piperazine; methyl piperazine; homopiperazine; diaminodiphenyl methanes; N,N′-diphenyl ethylene diamine; aminobenzamides; aminobenzhydrazides; bis(alkyl amino)phenylene diamines; melamine; triamino-hydroxy-pyrimidines; triamino-pyrimidines;pararosaniline; tris (aziridinyl) propionates; tetra amino biphenyls; bis (amino benzyl) anilines; mono (alkylamino) phenylene-diamines; bis (alkylamino) phenylene-diamines;aminomethylpiperidine; tetra-aminopyrimidines; N-methyl-m-phenylenediamine; N,N′-dimethyl-m-phenylenediamine, and combinations thereof.

35. The method of claim 19, wherein the first reactant comprises a first polymer polysiloxane.

36. The method of claim 19, wherein the second reactant comprises a second monomer or second polymer which has at least one functional group selected from a group consisting of carboxylic acids or acid chlorides, anhydride, isocyanate, chloroformate, and carbonate.

37. The method of claim 19, wherein the second reactant comprises a second monomer or second polymer selected from a group consisting of acid halide-terminated polyamide oligomers; benzene dicarboxylic acid halides; benzene tricarboxylic acid halides; cyclohexane dicarboxylic acid halides; cyclohexane tricarboxylic acid halides; pyridine dicarboxylic acid halides; trimellitic anhydride acid halides; benzene tetracarboxylic acid halides; pyromellitic acid di-anhydride; pyridine tricarboxylic acid halides; sebacic acid halides; azelaic acid halides; adipic acid halides; dodecanedioic acid halides; toluene diisocyanate; methylene bis (phenyl isocyanates);naphthalene diisocyanates; bitolyl diisocyanates; hexamethylene diisocyanate; phenylene diisocyanates; haloformyloxy benzene dicarboxylic acid halides; isocyanato benzene dicarboxylic acid halides; di (halosulfonyl) benzenes; halosulfonyl benzene dicarboxylic acid halides; cyclobutane dicarboxylic acid halides; dimethyl piperazine-N,N′-diformyl halides; piperazine-N,N′-diformyl halides; xylylene glycol di-haloformates; benzene diol di-haloformates; benzene triol tri-haloformates; phosgene; diphosgene; triphosgene; N,N′-carbonyl diimidazole; isocyanuric acid-N,N′,N″-triacetyl halide; isocyanuric acid-N,N′,N″-tripropionyl halide; cyclopentane tetracarboxylic acid halides and combinations thereof.

38. The method of claim 19, wherein the first reactant comprises a plurality of reactants.

39. The method of claim 19, wherein the second reactant comprises a plurality of reactants.
